(19) United States
(12) Patent Application Publication
(10) Pub. No.: US 2020/0306616 A1
(43) Pub. Date: Oct. 1, 2020

(54) THICKNESS CHECKING POINTER FOR BILLIARD PRACTICE

(71) Applicant: GO CUE INC., Incheon (KR)

(72) Inventors: Chul Hoon PARK, Incheon (KR); Jae Yong PARK, Incheon (KR); Seon Pyo HONG, Seoul (KR); Seok Kyung KIM, Seoul (KR); Kyung Yeon LEE, Seoul (KR)

(21) Appl. No.: 16/765,266

(22) PCT Filed: Nov. 7, 2018
(86) PCT No.: PCT/KR2018/013431

§ 371 Date: May 19, 2020

(30) Foreign Application Priority Data
Dec. 7, 2017 (KR) 10-2017-0167343

(51) Int. Cl. A63D 15/00; G01B 11/06

(52) U.S. Cl. CPC A63D 15/006; G01B 11/06

(57) ABSTRACT

A thickness checking pointer for billiard practice is provided, where while being fitted to a finger supporting a cue stick, the thickness checking pointer guides the cue stick to move in a straight line during forward and backward preparation motion or hitting motion of the cue stick, and emits a horizontal light beam in a travelling direction of the cue stick, so as to not only check which shape into which a cue ball and an object ball are arranged on the same straight line as the cue stick but also estimate the degree of thickness by which the cue ball moved upon hitting collides with the object ball, thereby enabling even beginners to easily understand billiards.

### BACKGROUND

The present invention relates to a thickness checking pointer for billiard practice and, more particularly, to a thickness checking pointer for billiard practice, in which the thickness checking pointer guides a cue stick to move in a straight line during forward and backward preparation motion or hitting motion of the cue stick while fitted to a finger supporting the cue stick, and emits a horizontal light beam in a travelling direction of the cue stick, so as to not only check which shape into which a cue ball and an object ball are arranged on the same straight line as the cue stick but also estimate the degree of thickness by which the cue ball moved upon hitting collides with the object ball, thereby enabling even beginners to easily understand billiards.

Generally, billiards are a kind of leisure sport in which each player competes for scores by hitting balls, such as a red or white ball, on a billiard table. There are many kinds billiards game, which may be divided into a carom game and a pocket game. The carom game includes four-ball billiards, balkline billiards, three-cushion billiards, and the like.

In addition, the cue stick used in the billiards game is made of a long rod formed by combining an upper stick and a lower stick, and is mainly made of a wood (or steel) material. Three or more billiard balls placed on the billiard table when playing billiards includes a cue ball which is hit by the cue stick, and first and second object balls that the cue ball hits while moving.

As for the basic elements of billiards constituted as described above, it is important to accurately hit a contact point of the cue ball with the cue stick, to determine the degree of the thickness by which the cue ball and the first object ball are collided with each other, and to determine the direction into which the cue ball is moved after colliding.

Among these basic elements of billiards, it is important to move the cue stick forward and backward on the same straight line during preparation motion (i.e., stroke) and hitting motion (i.e., shot) before hitting the cue ball. However, in the case of most beginners or lower intermediate level players, there is a problem in that the cue stick is shaken from side to side during the preparation and hitting motions of the cue stick, and thus a shot to an accurate position is not achieved. In addition, when the cue ball and the first object ball are placed close with each other, an error range for the thickness is narrow, but when the balls are placed in more than a certain distance, it is quite difficult to make the cue ball to collide with the first object ball with the desired thickness, and thus it takes a lot of time to master these techniques.

In Korean Patent No. 10-1759701 (registered on Jul. 13, 2017, hereafter referred to as “related document 1”), an auxiliary bridge for billiards has been proposed. The related document 1 relates to the auxiliary bridge for billiards, in which the auxiliary bridge plays a role of determining a position of the billiard cue hitting the cue ball, and guiding to-and-fro motion. The auxiliary bridge for billiards has a structure, including: a finger insertion ring to which a finger is inserted; a cue stand to put a cue on and act as a guide during stroke and shot motions; a light source marking a contact point on the cue ball by emitting a light beam toward the cue ball in parallel with the same direction as the direction of the front end part of the cue in order to sense the motion of the cue being guided on the cue stand. The related document 1 includes a structure in which the contact point is marked on the cue ball by the light source, but the structure may only provide a marking for the contact point in a relation between the cue stick and the cue ball, and is unable to provide information about the thickness between the cue ball and the object ball.

Korean Patent No. 10-1522636 (registered on May 18, 2015; hereafter referred to as “related document 2”), a billiards stroke training device has been proposed. In the related document 2, the device includes: a support provided in a shape extending in one direction and fixedly installed; a hitting part protrudingly formed of an elastic material bendable upward at one end part of the support and having a hitting aiming point formed at an upper end part thereof; a target part protrudingly formed upward at the other end part of the support and having a target aiming point formed at an upper end part thereof; and a plurality of auxiliary devices, each of which is formed of a plate having a curvature in cross section on both sides of each of the hitting part or the target part, wherein the hitting part and the target part are formed as a plate having a curvature in cross section, and the auxiliary devices and the hitting part, or the auxiliary devices and the target part are arranged in an arc shape. In the related document 2, a training enabling a user to accurately hit a contact point of a cue ball by a cue stick is provided, but this training device too is only able to hit the contact point of the cue ball and unable to provide information on the thickness between the cue ball and the object ball.

As such, in the existing billiard auxiliary devices, there are provided only devices that guide the position of the contact point relative to the cue ball or correct the stroke posture, and did not provide predictive information about the degree of the thickness by which the cue ball collides with the object ball according to the direction of the hit.

Therefore, there is a need for an auxiliary means that provides the information on the thickness by which the cue ball collides with the object ball, and that enables a user to hit in an accurate direction with the help of billiard learning.

### SUMMARY OF THE INVENTION

Accordingly, in a thickness checking pointer for billiard practice according to the present invention, an objective is to provide a device that emits a horizontal light beam in the same direction as a cue stick while fitted to a finger, wherein the device allows the horizontal light beam to pass through the center of a cue ball to be emitted to an object ball, so that a user may know in advance the degree of the thickness by which the cue ball collides with the object ball when hitting.

In addition, another objective of the thickness checking pointer for billiard practice according to the present invention is to provide a device capable of checking in advance the thickness of a cue ball thinly colliding with an object ball, by emitting three horizontal light beams including a central horizontal light beam in the hitting direction and two lateral horizontal light beams that are emitted, each light beam being spaced apart from the central horizontal light beam at a certain angle to the left and right by a width of the object ball.

A thickness checking pointer for billiard practice of the present invention for solving the above problems is configured to include:

in a thickness checking pointer to use by being fitted to a finger, a light beam emitter provided with a main body having an accommodation space formed therein, a light beam emitting part, a power supply part, and a controller installed in the accommodation space of the main body, a button part formed on an outer surface of the main body to operate the light beam emitting part, and a horizontal light beam filter installed on a front of the main body and transmitting a light beam emitted from the light beam emitting part in a form of a horizontal light beam so as to simultaneously emit the horizontal light beam to a cue ball at a short-range and an object ball at a long-range; and a ring handle extending from the main body of the light beam emitter to an upper part or a lower part thereof to form a ring to be fitted to the finger.

In addition, the ring handle may extend to a lower part of the main body of the light beam emitter, but may be configured to be fitted to an index finger in the width direction crossing a longitudinal direction which is a light beam emitting direction, and may be further provided with a guide groove formed on a bottom surface of the ring handle in the longitudinal direction which is the light beam emitting direction, so that the guide groove may be slidably contacting with an upper part surface of a cue stick to guide the cue stick to move only in the longitudinal direction.

As another example, the ring handle may extend to an upper part of the main body of the light beam emitter, but may be configured to be fitted to an index finger in the width direction crossing a longitudinal direction which is a light beam emitting direction, and may be further provided with a guide groove formed on a bottom surface of the main body of the light beam emitter in the longitudinal direction which is the light beam emitting direction, so that the guide groove may be slidably contacting with an upper part surface of a cue stick to guide the cue stick to move only in the longitudinal direction.

In addition, the horizontal light beam filter of the light beam emitter may be provided with three horizontal light beam transmitting part to be spaced apart at regular intervals in a width direction so that three horizontal light beams (42) may be emitted. The three horizontal light beams may be configured to adjust intervals between the emitting light beams.

In addition, an interval between the horizontal light beams may be adjusted by a forward and backward movement means for moving the horizontal light beam filter in a front-rear direction.

The forward and backward movement means may be configured to include: a support movably supporting the horizontal light beam filter in the front-rear direction; a rotating rod having one end thereof exposed to outside of the main body of the light beam emitter and manually receiving rotational force; and a gear box moving the horizontal light beam filter in the front-rear direction by rotation of the rotating rod.

In addition, the forward and backward movement means may include: a support movably supporting the horizontal light beam filter in the front-rear direction; a gear box moving the horizontal light beam filter in the front-rear direction; and a motor transmitting power to the gear box, and a sensor is mounted on the front of the main body of the light beam emitter to measure a distance to the object ball by the sensor, and then, by operating the forward and backward movement means, an entire width of three horizontal light beams reaching the object ball is formed to have a same width as a width of the object ball.

In the present invention proposed to solve the problem, the thickness checking pointer is configured in a form of being fitted to a finger to emit a light beam, wherein the emitted light beam is provided as a horizontal light beam so that the cue stick, the cue ball, and the first object ball are placed on the same straight line, thereby enabling a user to estimate to what degree of the thickness the cue ball that is hit may collide with the first object ball.

In particular, by providing three horizontal light beams spaced apart by the radius of a billiard ball, it is possible to predict that the cue ball and the first object ball collide with each other by a thin thickness. Accordingly, all of the trainees entering billiards, the beginners, and the users with no confidence in the thickness may get an assistance for understanding the billiards thickness, thereby being able to provide a useful device that may help improving billiards skills.

### BRIEF DESCRIPTION OF DRAWINGS

FIG. 1 is a perspective view showing a thickness checking pointer according to an exemplary embodiment of the present invention.

FIG. 2 is a configuration diagram showing a light beam emitter according to the exemplary embodiment of the present invention.

FIGS. 3a and 3b are respectively a side view and a front view of the thickness checking pointer according to the present invention.

FIGS. 3c and 3d are side views showing the thickness checking pointer to which various ring handles are applied according to the present invention.

FIGS. 4a and 4b are respectively a side view and a front view showing the thickness checking pointer provided with the ring handle formed at an upper part thereof according to the present invention.

FIG. 4c is a plan view showing the light beam emitter formed with a finger insertion groove on the side thereof according to the present invention.

FIG. 5 is a schematic diagram showing a state of use of the thickness checking pointer according to the exemplary embodiment of the present invention.

FIG. 6 is a configuration diagram showing the light beam emitter in which three horizontal light beams are emitted and a distance therebetween is manually adjusted according to another exemplary embodiment of the present invention.

FIGS. 7a and 7b are respectively a configuration diagram and a process diagram showing the light beam emitter in which three horizontal light beams are emitted and a distance is manually adjusted according to another exemplary embodiment of the present invention.

FIG. 8 is a schematic diagram showing the state of use of the thickness checking pointer according to another exemplary embodiment of the present invention.

### DETAILED DESCRIPTION OF THE INVENTION

Hereinafter, the present invention will be described in more detail with reference to the drawings. However, the accompanying drawings are only examples for easily explaining the content and scope of the technical idea of the present invention, and the technical scope of the present invention is not limited or changed by these exemplary embodiments. In addition, it will be apparent to those skilled in the art that various modifications and changes can be made within the scope of the present invention based on these examples.

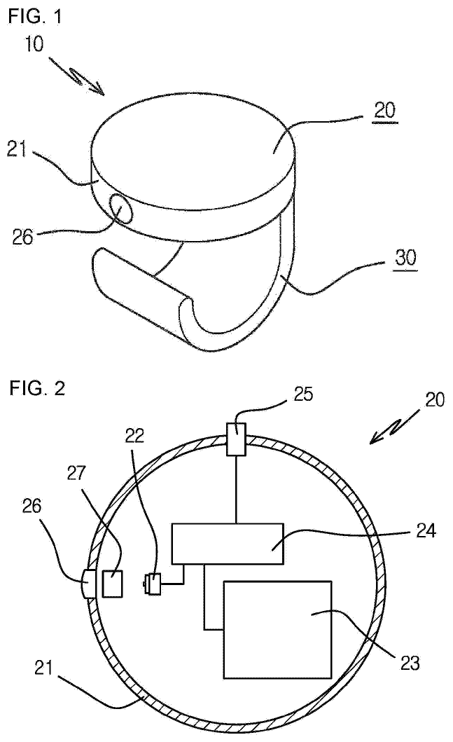

FIG. 1 is a perspective view showing a thickness checking pointer according to an exemplary embodiment of the present invention, and FIG. 2 is a configuration diagram of a light beam emitter.

As mentioned, the thickness checking pointer 10 according to the present invention is configured, including: a light beam emitter 20; and a ring handle 30 extended from one side of the light beam emitter and fitted to a finger.

The light beam emitter 20 is provided with a main body 21 formed therein with an accommodation space in which various parts including a light beam emitting part 22, a power supply part 23, and a controller 24 are placed. As shown in the drawings, the main body 21 may be formed in a disc shape or may be configured in various shapes such as a square or a rectangle, and all or a part of an upper part surface or a lower part surface may be configured as a removable cover, so that various parts inside the main body may be easily repaired or replaced.

In the case of the removable structure, such a main body is preferably provided in a watertight structure by installing a seal including an O-ring in the coupling parts.

The light beam emitting part 22, the power supply part 23, and the controller 24 are installed in the accommodation space of the main body 21. The light beam emitting part 22 generates light beams by receiving power from the power supply part 23, in which an LED or a laser diode may be used in general and a light beam condensing part that concentrates the generated light beams in one direction may be included therein.

The power supply unit 23 may use a replaceable primary or secondary battery, or a rechargeable secondary battery. In the case of the replaceable type battery, a cover may be formed on the main body as described above to allow the battery to be replaced and installed by detaching and attaching the cover. In the case of the rechargeable type battery, a charging terminal may be formed on one side of the main body to allow the battery to be charged from the outside by a charging cable or a wireless charging method.

When the controller 24 receives an operation signal from outside, the controller 24 connects the power supply part 23 and the light beam emitting part 22 to each other to supply the power. In this case, the amount of time for emitting light may be provided either in a way that the light beam is emitted by the power supply only while the operation signal is input, or in a way that the power is supplied only for a certain time period from the input time when the operation signal is input and the power supply is automatically cut off afterward.

A button part 25 for operating the light beam emitting part 22 may be further provided at a position on an outer surface of the main body 21. The button part is mounted in a structure that enables an elastic repulsion by a spring, so that the button returns to its original position when pressing power is removed.

In addition, the main body 21 may be equipped with a floodlight lens 26 in the front direction thereof so that the light generated from the light beam emitting part 22 may be emitted to the outside through the floodlight lens. The floodlight lens 26 is mounted in a through-hole formed on the main body, and an edge of the floodlight lens is sealed to make airtight the inside of the main body, thereby blocking foreign matter from being introduced therein and emitting the light beams.

In addition, a horizontal light beam filter 27 is additionally installed between the floodlight lens 26 and the light beam emitting part 22. The horizontal light beam filter 27 horizontally transforms a condensed light beam generated by the light beam emitting part, and the transformed horizontal light beam is finally emitted to the outside through the floodlight lens. In addition, in order to further condense the generated light beam into the horizontal light beam emitted in the horizontal line, the horizontal light beam filter may condense the light beam into a horizontal line by forming a reflective surface in a shape of a triangular pyramid having a wide surface in the direction of the light beam emitting part and having a narrow surface in the direction of the floodlight lens. In this case, the floodlight lens may be formed as a flat lens to let the light beam pass through, or may be formed as a convex lens to make an up and down length of the horizontal light longer which is horizontally condensed, and the light irradiation may be performed. In addition, the horizontal light beam filter 27 may be provided in a structure in which the reflecting surface is formed in a shape of a triangular pyramid with a rectangular transparent body. In this case, a square groove corresponding to the horizontal light beam filter may be formed inside the main body, so that the horizontal light beam filter may be simply fitted and fixed to the square groove. The ring handle 30 is provided with a ring extending toward the upper part or the lower part from any one surface of the main body of the light beam emitter to allow a finger to fit thereto in the width direction crossing the longitudinal direction which is the emitting direction of the light beam.

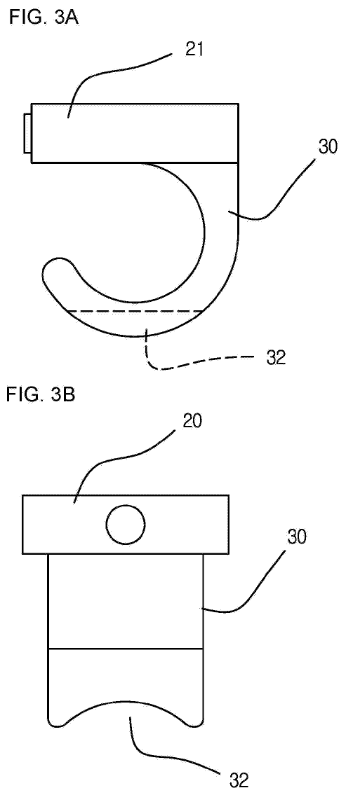

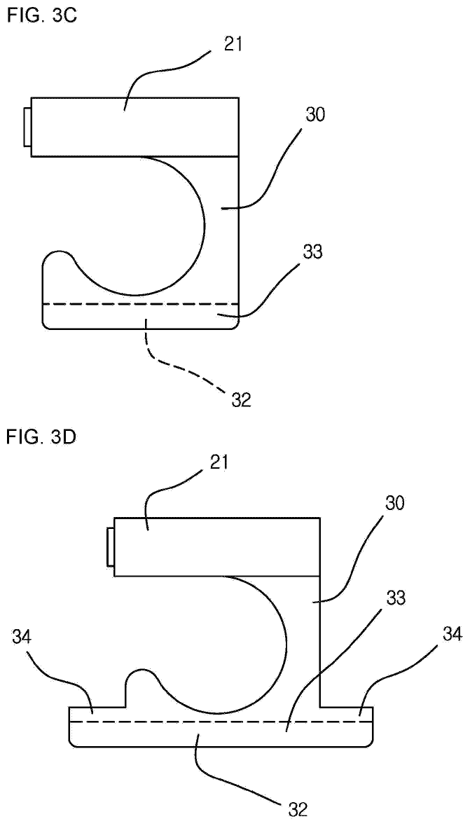

In the present invention, of a hand that supports the cue stick, an index finger (i.e., forefinger) surrounding the upper part of the cue stick is provided with the ring having a form to which the index finger fits. When the ring handle extends to the upper part of the light beam emitter, the light beam emitter is positioned between the cue stick and the index finger, and when the ring handle extends to the lower part of the light beam emitter, the light beam emitter is positioned on the upper part of the index finger, and thus the light beam is emitted. Referring to the first exemplary embodiment of FIGS. 3a and 3b, the ring handle 30 is extended to a certain thickness and width and provided in the form of a hook or a ring as shown in the drawings to be fitted and fixed to the finger.

Here, the ring handle 30 may be made of an elastic material so that constant elastic deformation may be provided. That is, when the ring handle is provided in the form of the hook, the inner diameter thereof is formed smaller than a diameter of an adult's finger so that the ring handle is in close contact with the user's finger by the elastic deformation when fitted to the finger, and thus the fitted position may be prevented from changing due to the external force.

In addition, an anti-slip layer 31 may be further coated on the inner surface of the ring handle 30. The anti-slip layer 31 may be coated by using a rubber material having a high friction force, or by using a rubber material having a high adhesive force, thereby maximally reducing the positional change due to the external force after being fitted.

In addition, as a means for increasing the friction force, a plurality of protrusions on the inner surface of the ring handle may be formed to protrude. Alternatively, the anti-slip layer may be partially applied to increase the friction force.

In addition, even when providing the ring handle 30 in the form of the ring, the inner diameter thereof may be formed to be 10 to 40% smaller than the finger of the adult so that the finger firmly fits thereto by the elastic deformation of the same elastic material and coating of the anti-slip layer as in the case of the hook form.

In addition, a guide groove 32 is further formed on the bottom surface of the ring handle 30. As shown in FIGS. 1, 3a, and 3b, the ring handle 30 extends to the lower part of the main body 21 of the light beam emitter, and the guide groove 32 is formed at a position on the bottom surface of the extended part in the same longitudinal direction as the light beam emitting direction. The guide groove 32 may be provided in various forms such as a U-shaped groove or a V-shaped groove capable of stably supporting the cue stick having a circular cross section, and may be formed long in the longitudinal direction of the light beam emitting direction.

The guide groove 32 is formed as long as possible from the bottom surface of the ring handle 30, formed in a curved surface, so as to increase the surface area being in contact with the cue stick. Thus, during the preparation motion or the hitting motion, the cue stick may be guided by the guide groove so that only linear movement may be performed as much as possible without shaking left and right.

In addition, in order to increase the supporting area of the guide groove 32, as shown in FIG. 3c, the bottom surface of the ring handle 30 may be expanded horizontally and the expanded bottom surface expansion part 33 may be provided with the guide groove 32 formed long, thereby increasing the surface supported by contacting with the cue stick.

In addition, in the ring handle 30, as shown in FIG. 3d, a bottom surface extension part 34 extended either one side or both sides of both end parts of the bottom surface expansion part 33 in the longitudinal direction may be additionally formed to make the length of the guide groove 32 longer, which guides the linear movement of the cue stick, thereby preventing the cue stick from shaking left and right during the preparation motion or the hitting motion of the cue stick.

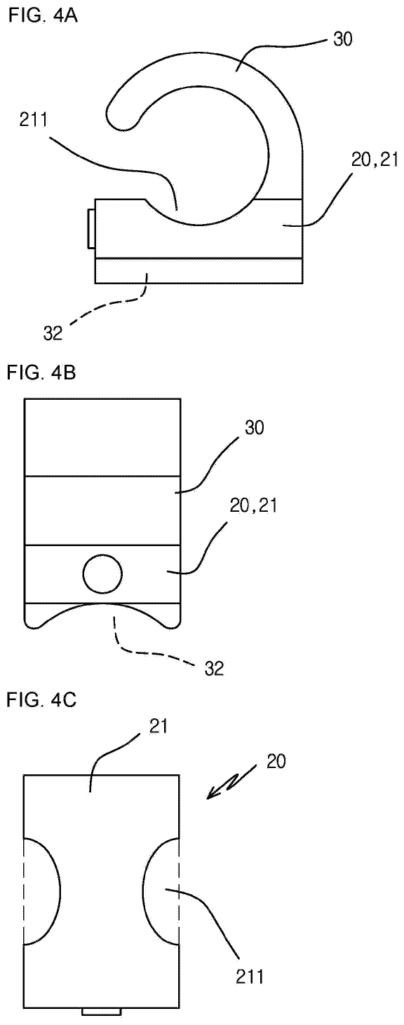

As shown in the second exemplary embodiment of FIGS. 4a and 4b, when the ring handle 30 has a form extending to the upper part of the light beam emitter 20, it is preferable to maximally reduce the width and thickness of the light beam emitter. For example, the upper surface of the main body 21 of the light beam emitter is provided with a finger settling groove 211 that recesses a part being contacted with the index finger surrounding the upper part of the cue stick, so as to allow the index finger to be inserted therein. Therefore, by maximally reducing the thickness of the light beam emitter inserted between the cue stick and the index finger, it is possible to maximally reduce the feeling of irritation of the finger during the preparation motion or the hitting motion of the cue stick.

In this case, the finger settling groove 211 may be formed only on the upper surface of the main body, or on the sides of the main body as shown in FIG. 4c to maximally reduce the gap between a cue stick and the finger surrounding the upper part of the cue stick.

In addition, in the second exemplary embodiment, the guide groove 32 may be formed on the bottom surface of the main body 21 of the light beam emitter in the longitudinal direction, which is the light beam emitting direction, and the cue stick may be inserted into the guide groove so as to guide the cue stick to move in a straight line without shaking left and right. In addition, the guide groove 32 may be formed directly on the bottom surface of the main body, or may be formed by a method of attaching an auxiliary member that forms the guide groove on the bottom surface of the main body.

Having the above-described configuration, the thickness checking pointer 10 of the present invention is used by being fitted to a finger surrounding the upper part of the cue stick, of the hand where the user supports the cue stick.

When the thickness checking pointer 10 is operated, the horizontal light beam 40 is emitted in the same direction as the guide groove direction in the light beam emitter. At this time, since the cue stick is aligned in the guide groove of the thickness checking pointer, the horizontal light beam is emitted from the upper surface of the cue stick in the longitudinal direction of the cue stick to form a horizontal line, and the center of the cue ball 60 and the object ball 70 are positioned on the horizontal line.

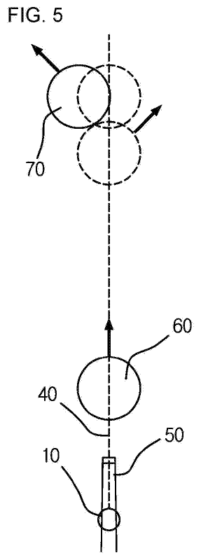

Therefore, as shown with reference to FIG. 5, when the user aims the first object ball 71 while facing the center of the cue ball 60, since the horizontal light beam 40 forms a line to the center of the cue stick 50, the center of the cue ball 60, and the first object ball 71, it is possible to determine to what degree of the thickness the cue ball 60 collides with the first object ball 71 upon being hit. In this regard, since the direction in which the cue ball 60 proceeds after hitting the first object ball 71 may be easily determined, the invention may be used for beginners or practicing users to easily figure out the thickness of the object ball.

Meanwhile, the horizontal light beam filter 27 of the light beam emitter is provided with three horizontal light beam transmitting parts 271 at regular intervals in the width direction, so that three horizontal light beams such as one central horizontal light beam 41 and two lateral horizontal light beams 42 may be emitted. At this time, the horizontal light beam filter 27 may adjust the interval from the light beam emitting part 22 so that the central horizontal light beam 41 and the lateral horizontal light beams 42 are emitted at a certain angle, and thus the width between the horizontal light beams may be adjustable.

That is, in the horizontal light beam filter, three horizontal light beam transmitting parts may be printed to be formed at regular intervals on the surface of the convex lens of which the exit direction is convex, whereby the angle between each of the horizontal light beam transmitting parts may be finely controlled by adjusting the intervals from the light source.

For example, in the process of moving the horizontal light beam filter 27 in the front-rear direction by a forward and backward movement means 28, the interval from the light beam emitting part 22 as the light source is adjusted so that the interval between the horizontal light beams 40 emitted through each of the horizontal light beam transmitting parts 271 may be adjusted. The interval adjustment is made at a fine angle, and an interval between horizontal light beams at the desired distance may be set to the interval with a length of the diameter or radius of a billiard ball.

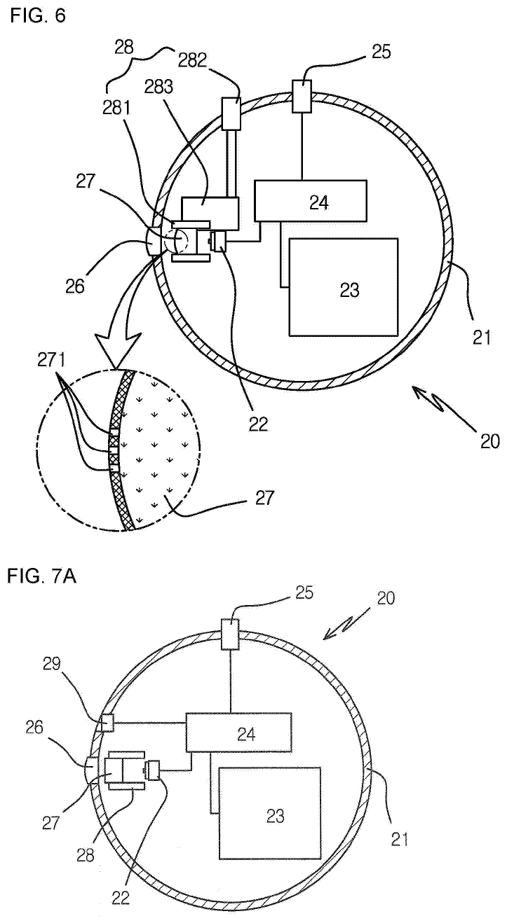

As shown in FIG. 6, the forward and backward movement means 28 is configured, including: a support 281 movably supporting the horizontal light beam filter 27 in the front-rear direction; a rotating rod 282 having one end exposed to the outside of the main body 21 of the light beam emitter to manually receive rotational force; and a gear box 283 moving the horizontal light beam filter in the front-rear direction by rotation of the rotating rod.

The support 281 may be composed of a frame, or may be an internal groove of the main body of the light beam emitter. The rotating rod 282 has a structure in which a user directly rotates the rotating rod to transmit rotational power, but the rotating rod may be composed of a rotation button, wherein a motor is mounted between the rotation button and the gear box to operate the motor by clicking the rotation button to generate the rotational power. In addition, the gear box 283 may decelerate the transmitted rotational force and transmit it to the filter to allow the horizontal light beam filter to move finely. In addition, various means may be applied to connect the horizontal light beam filter 27 and the gear box 283 to each other, such that a gear is installed on one side of the horizontal light beam filter, and then the rotational force is converted into a linear force for moving by using a worm and a worm wheel, or a rack and a pinion.

In addition, although the present invention has been described as a method of moving the horizontal light beam filter 27, the horizontal light beam filter may be fixed to the main body, and the forward and backward movement means may be installed on the light beam emitting part to adjust the interval between the horizontal light beam filter and the light beam emitting part by moving the light beam emitting part.

Such a manual method allows the user to manually adjust the intervals between the three horizontal light beams at the position where the first object ball is placed. In addition, the interval may also be adjusted automatically by a sensor.

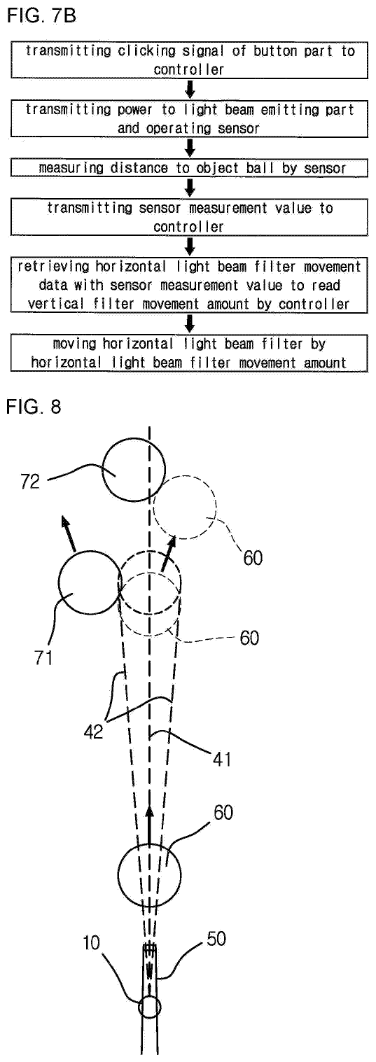

As referenced FIG. 7a, the forward and backward movement means 28 may be configured to include: the support 281 movably supporting the horizontal light beam filter 27 of the light beam emitter in the front-rear direction; the gear box 283 moving the horizontal light beam filter in the front-rear direction; and a motor 284 for transmitting power to the gear box. In this case, a sensor 29 is mounted on the front surface of the main body 21 of the light beam emitter, the distance to the object ball is measured by the sensor 29, and then, by operating the forward and backward movement means 28, the entire width of the three horizontal light beams reaching the object ball is formed to be the same width as the width of the object ball. That is, the distance to the object ball is measured by the sensor 29, and according to the measured value, the desired interval at the object ball position may be set by moving the horizontal light beam filter comparing with the horizontal light beam filter movement data. The horizontal light beam filter movement data represents a movement value of the horizontal light beam filter depending on the distance.

Referring to FIGS. 7a and 7b to describe the automatic operation process of the forward and backward movement means, first, a first step is performed, in which a clicking signal of the button part 25 of the light beam emitter is transmitted to the controller 24. The button part generates an operation signal and transmits it to the controller, and a button for operating the light beam emitting part and a button for operating the sensor may be configured as one button or separate buttons, so that each signal may be generated and transmitted to the controller.

Next, the second step is a step in which the controller 24 that receives the operation signal transmits the power of the power supply part 23 to the light beam emitting part 22 to operate the sensor 29 while emitting light beams. That is, when the operation signal is transmitted, the controller transmits power to the light beam emitting part, and simultaneously supplies power to the sensor to be operated.

The third step is a step to measure a distance to the object ball by the sensor 29 which is operated by receiving power. Measuring the distance is performed using infrared, ultrasonic, laser, or the like. The distance measurement by the sensor may be performed either for one of the balls in the directions the sensor is facing, or for both of the cue ball at the short-range and the object ball at the long-range in a certain area, for example, in a 2 to 5° from left to right area, by the left and right scanning of the sensor.

The fourth step is a step in which the sensor value measured by the sensor 29 is transmitted to the controller 24.

In this step, according to the setting, only the sensor value measured for any one of the balls the sensor is facing is transmitted, or both the sensor values measured for the cue balls within short-range and the object ball within long-range are transmitted to the controller.

The fifth step is a step in which the controller determines the horizontal light beam filter movement amount based on the measured values received from the sensor. That is, in this step, the controller 24 sets a basis with the sensor value for the long-range, selected from either two sensor values or a sensor value, which are transmitted from the sensor 29. Then, the controller 24 retrieves horizontal light beam filter movement data from database DB that stores a horizontal light beam filter movement amount calculated with the separation distance, so as to read the horizontal light beam filter movement amount corresponding to the distance of the sensor value.

The sixth step is a step in which the controller 24 supplies the power of the power supply part 23 to the motor 284 so as to move the horizontal light beam filter by the horizontal light beam filter movement amount, which has been read.

Through the movement process of the forward and backward movement means, three horizontal light beams are emitted while spaced apart at a certain angle from the light beam emitter, wherein the total separation angle of the three horizontal light beams is formed at an angle having a width equal to the diameter of the billiard ball at the position where the first object ball is placed.

Referring to FIG. 8 to describe, the angle between the first and second object balls 71 and 72 is formed small. In this case, only when the cue ball 60 is hit by the cue stick 50, and while moving, the hit cue ball 60 collides thinly with the first object ball 71, the cue ball may hit the second object ball 72 by way of minimizing the bending angle caused by the collision.

However, because the thickness checking pointer for emitting one horizontal light beam of the present invention emits a horizontal light beam around the center of the cue ball, even when the horizontal light beam is emitted to the outermost circumference of the first object ball, the thickness checking pointer is unable to check whether the cue ball is thinly collided with the first object ball due to the reason that the cue ball is overlappingly collided with the first object ball by the thickness of about the radius of the cue ball.

Therefore, in order for the cue ball to collide thinly with the first object ball, the thickness checking pointer should emit the beams in the direction away from the surface of the first object ball, and thus no assistance from horizontal light beam is available for thin thickness.

Accordingly, in the case where a total of three horizontal light beams, such as one central horizontal light beam 41 and two lateral horizontal light beams 42 each spaced apart from each other to the left and right with the interval of the radius of billiard ball from the central horizontal light beam, are emitted, the central horizontal light beam 41 is aligned at the center of the cue ball 60, and as for the first object ball 71, the lateral horizontal light beam 42 is emitted at a position closest to the outermost angle of the first object ball 71, while referencing the lateral horizontal light beam 42 as a baseline in the direction of collision among the two lateral horizontal light beams. As described above, when the arrangement is completed, the cue ball 60 is hit with the cue stick 50, and while moving along the central horizontal light beam 41, the cue ball 60 which is hit is thinly collided with the first object ball 71, and then, moves to hit the second object ball 72 while maximally reducing the bending angle. Therefore, in the thickness checking pointer 10 of the present invention, the emitted horizontal light beam 40 is marked on all of the cue stick 50, the cue ball 60, and the first object ball 71, whereby it is possible to provide a device that may assist in understanding billiards by easily predicting to what degrees of the thickness the cue ball 60 may hit the first object ball 71 upon hitting the cue ball.

1. A thickness checking pointer to use by being fitted to a finger, the thickness checking pointer comprising:
a light beam emitter (20) provided with
a main body (21) having an accommodation space formed therein,
a light beam emitting part (22), a power supply part (23), and a controller (24) installed in the accommodation space of the main body,
a button part (25) formed on an outer surface of the main body to operate the light beam emitting part, and
a horizontal light beam filter (27) installed on a front of the main body and transmitting a light beam emitted from the light beam emitting part in a form of a horizontal light beam so as to simultaneously emit the horizontal light beam to a cue ball at a short-range and an object ball at a long-range; and
a ring handle (30) extending from the main body (21) of the light beam emitter to an upper part or a lower part thereof to form a ring to be fitted to the finger,
wherein the horizontal light beam filter (27) of the light beam emitter is provided with three horizontal light beam transmitting part (271) to be spaced apart at regular intervals in a width direction so that one central horizontal light beam (41) and two lateral horizontal light beams (42) are emitted.

2. The thickness checking pointer of claim 1, wherein the ring handle (30) extends to a lower part of the main body (21) of the light beam emitter, but is configured to be fitted to an index finger in the width direction crossing a longitudinal direction which is a light beam emitting direction, and is further provided with a guide groove (32) formed on a bottom surface of the ring handle (30) in the longitudinal direction which is the light beam emitting direction, so that the guide groove (32) is slidably contacting with an upper part surface of a cue stick (50) to guide the cue stick to move only in the longitudinal direction.

3. The thickness checking pointer of claim 2, wherein the ring handle (30) is further provided with a bottom surface expansion part (33) having a bottom surface thereof horizontally expanded, so as to increase a length of the guide groove (32).

4. The thickness checking pointer of claim 3, wherein the ring handle (30) is further provided with a bottom surface extension part (34) which longitudinally extends either any one side or both sides of both end parts in the longitudinal direction of the bottom surface expansion part having a bottom surface thereof horizontally formed, so as to increase the length of the guide groove (32).

5. The thickness checking pointer of claim 1, wherein the ring handle (30) extends to an upper part of the main body (21) of the light beam emitter, but is configured to be fitted to an index finger in the width direction crossing a longitudinal direction which is a light beam emitting direction, and is further provided with a guide groove (32) formed on a bottom surface of the main body (21) of the light beam emitter in the longitudinal direction which is the light beam emitting direction, so that the guide groove (32) is slidably contacting with an upper part surface of a cue stick (50) to guide the cue stick to move only in the longitudinal direction.

6. The thickness checking pointer of claim 1, wherein the central horizontal light beam (41) and the lateral horizontal light beam (42) adjust interval between emitting light beams.

7. The thickness checking pointer of claim 6, wherein an interval between the central horizontal light beam (41) and the lateral horizontal light beam (42) is adjusted by a forward and backward movement means (28) for moving the horizontal light beam filter (27) in a front-rear direction.

8. The thickness checking pointer of claim 7, wherein the forward and backward movement means (28) comprises:
a support (281) movably supporting the horizontal light beam filter (27) in the front-rear direction;
a rotating rod (282) having one end thereof exposed to outside of the main body of the light beam emitter and manually receiving rotational force; and
a gear box (283) moving the horizontal light beam filter in the front-rear direction by rotation of the rotating rod.

9. The thickness checking pointer of claim 7, wherein the forward and backward movement means (28) comprises:
a support (281) movably supporting the horizontal light beam filter (27) in the front-rear direction;
a gear box (283) moving the horizontal light beam filter in the front-rear direction; and
a motor (284) transmitting power to the gear box, and
a sensor (29) is mounted on the front of the main body of the light beam emitter to measure a distance to the object ball by the sensor, and then, by operating the forward and backward movement means, an entire width of three horizontal light beams reaching the object ball is formed to have a same width as a width of the object ball.

10. The thickness checking pointer of claim 9, wherein the forward and backward movement means (28) is controlled by:
a first step in which a clicking signal of the button part (25) of the light beam emitter is transmitted to the controller (24);
a second step in which the controller (24) operates the sensor (29) while transmitting the power of the power supply part (23) to the light beam emitting part (22) to emit the light beam;
a third step in which the distance to the object ball (70) is measured by the sensor (29) being operated;
a fourth step in which a sensor value measured by the sensor (29) is transmitted to the controller (24);
a fifth step in which the controller (24) reads a horizontal light beam filter movement amount by comparing a measured distance value with the horizontal light beam filter movement data storing the horizontal light beam filter movement amount according to a previously stored separation distance; and
a sixth step in which the controller (24) supplies the power of the power supply part (23) to the motor (284) to move the horizontal light beam filter (27) by the horizontal light beam filter movement amount which is read out.
